(19) United States
(12) Patent Application Publication
(10) Pub. No.: US 2026/0370173 A1
(43) Pub. Date: Nov. 19, 2026

(54) ALTERNATING CURRENT BATTERY HEATING THROUGH IN-VEHICLE HIGH VOLTAGE BUS RESONANCE DETECTION

(71) Applicant: GM Global Technology Operations LLC, Detroit, MI (US)

(72) Inventors: Neeraj S. Shidore, Novi, MI (US); Abir Chatterjee, Novi, MI (US); Mohammad N. Anwar, Northville, MI (US); Suresh Gopalakrishnan, Troy, MI (US); Chandra S. Namuduri, Troy, MI (US); Renato Amorim Torres, Pontiac, MI (US)

(21) Appl. No.: 19/211,643

(22) Filed: May 19, 2025

(51) Int. Cl. H02P 29/62; H01M 10/615; H01M 10/633; B60L 50/60; B60L 58/27

(52) U.S. Cl. CPC H02P 29/62; H01M 10/615; H01M 10/633; B60L 50/60; B60L 58/27; H01M 2220/20

(57) ABSTRACT

An electrical system performs a method of heating a battery of a vehicle. The electrical system includes a battery, an inverter electrically coupled to the battery, and a processor. The processor sweeps a ripple current at the inverter through a plurality of frequencies, wherein the inverter is associated with the battery, detects a plurality of battery currents at the battery in response to the ripple current, each battery current of the plurality of battery currents corresponding to a frequency of the ripple current, determines a magnitude for each battery current, determines a resonance frequency of the ripple current for which the magnitude of the battery current is a maximum, and operates the inverter at the resonance frequency of the ripple current to heat the battery.

The subject disclosure relates to operation of electric vehicles and, in particular, to a system and method for heating a battery of the electric vehicle using ripple currents.

An electric vehicle uses a battery or direct current (DC) power source, an inverter and an electric motor. The inverter converts DC voltage from the battery into alternating current (AC) voltage for use at the electric motor. Cold weather or cold conditions can affect the operation of the battery. Accordingly, it is desirable to provide, a method for heating the battery to an optimal operating temperature.

In one exemplary embodiment, a method of heating a battery of a vehicle is disclosed. The method includes sweeping a ripple current at an inverter of the vehicle through a plurality of frequencies, wherein the inverter is associated with the battery, detecting a plurality of battery currents at the battery in response to the ripple current, wherein a battery current of the plurality of battery currents corresponds to a frequency of the ripple current, determining a magnitude for each battery current, determining a resonance frequency of the ripple current for which the magnitude of the battery current is a maximum, and operating the inverter at the resonance frequency of the ripple current to heat the battery.

In addition to one or more of the features described herein, the method further includes creating the ripple current at the inverter by operating switches of the inverter asynchronously.

In addition to one or more of the features described herein, the inverter is coupled between the battery and a motor and the ripple current is injected into the motor along a d-axis of the motor.

In addition to one or more of the features described herein, the method further includes adjusting a fundamental frequency of the ripple current along the d-axis to be one of equal to the resonance frequency and half of the resonance frequency.

In addition to one or more of the features described herein, wherein the inverter includes a first inverter between the battery and a first motor and a second inverter between the battery and a second motor, the method further includes determining a first resonance frequency for a first ripple current at the first inverter that corresponds to a first peak in a gain of the battery current, determining a second resonance frequency for a second ripple current at the second inverter that corresponds to a second peak in the gain of the battery current, and selecting one of the first inverter and the second inverter for heating the battery based on which the first peak and the second peak is greatest.

In addition to one or more of the features described herein, the method further includes determining a frequency and phase for operating a first motor associated with the first inverter and a second motor associated with the first inverter and a phase difference between the first motor and the second motor for optimal heating at the battery.

In addition to one or more of the features described herein, the method further includes repeating sweeping of the ripple current to determine the resonance frequency at a subsequent time as the battery heats up.

In another exemplary embodiment, an electrical system of a vehicle is disclosed. The electrical system includes a battery, an inverter electrically coupled to the battery, and a processor. The processor is configured to sweep a ripple current at the inverter through a plurality of frequencies, wherein the inverter is associated with the battery, detect a plurality of battery currents at the battery in response to the ripple current, each battery current of the plurality of battery currents corresponding to a frequency of the ripple current, determine a magnitude for each battery current, determine a resonance frequency of the ripple current for which the magnitude of the battery current is a maximum, and operate the inverter at the resonance frequency of the ripple current to heat the battery.

In addition to one or more of the features described herein, the processor is further configured to create the ripple current at the inverter by operating switches of the inverter asynchronously.

In addition to one or more of the features described herein, the inverter is coupled between the battery and a motor and the ripple current is injected into the motor along a d-axis of the motor.

In addition to one or more of the features described herein, the processor is further configured to adjust a fundamental frequency of the ripple current along the d-axis to be one of equal to the resonance frequency and half of the resonance frequency.

In addition to one or more of the features described herein, the inverter includes a first inverter between the battery and a first motor and a second inverter between the battery and a second motor and the processor is further configured to determine a first resonance frequency for a first ripple current at the first inverter that corresponds to a first peak in a gain of the battery current, determine a second resonance frequency for a second ripple current at the second inverter that corresponds to a second peak in the gain of the battery current, and select one of the first inverter and the second inverter for heating the battery based on which the first peak and the second peak is greatest.

In addition to one or more of the features described herein, the processor is further configured to determine a frequency and phase for operating a first motor associated with the first inverter and a second motor associated with the second inverter and a phase difference between the first motor and the second motor for optimal heating at the battery.

In addition to one or more of the features described herein, the processor is further configured to repeat sweeping of the ripple current to determine the resonance frequency at a subsequent time as the battery heats up.

In yet another exemplary embodiment, a vehicle is disclosed. The vehicle includes a battery, an inverter electrically coupled to the battery, a detector coupled to the battery for detecting a plurality of battery currents at the battery, and a processor. The processor is configured to sweep a ripple current at the inverter through a plurality of frequencies, wherein the inverter is associated with the battery, receive the plurality of battery currents from the detector in response to the ripple current, each battery current of the plurality of battery currents corresponding to a frequency of the ripple current, determine a magnitude for each battery current, determine a resonance frequency of the ripple current for which the magnitude of the battery current is a maximum, and operate the inverter at the resonance frequency of the ripple current to heat the battery.

In addition to one or more of the features described herein, the processor is further configured to create the ripple current at the inverter by operating switches of the inverter asynchronously.

In addition to one or more of the features described herein, the inverter is coupled between the battery and a motor and the ripple current is injected into the motor along a d-axis of the motor.

In addition to one or more of the features described herein, the processor is further configured to adjust a fundamental frequency of the ripple current along the d-axis to be one of equal to the resonance frequency and half of the resonance frequency.

In addition to one or more of the features described herein, the inverter includes a first inverter between the battery and a first motor and a second inverter between the battery and a second motor and the processor is further configured to determine a first resonance frequency for a first ripple current at the first inverter that corresponds to a first peak in a gain of the battery current, determine a second resonance frequency for a second ripple current at the second inverter that corresponds to a second peak in the gain of the battery current, and select one of the first inverter and the second inverter for heating the battery based on which the first peak and the second peak is greatest.

In addition to one or more of the features described herein, the processor is further configured to determine a frequency and phase for operating a first motor associated with the first inverter and a second motor associated with the first inverter and a phase difference between the first motor and the second motor for optimal heating at the battery.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an embodiment of a vehicle, which includes a vehicle body defining, at least in part, an occupant compartment;

FIG. 2 is a schematic diagram of an electrical system of the electric vehicle, in an illustrative embodiment;

FIG. 3 shows a flowchart of a method for determining an optimal frequency for warming a battery using a ripple current;

FIG. 4 shows three graphs for illustrating the method for determining the optimal frequency disclosed by the flowchart of FIG. 3;

FIG. 5 shows a phase diagram between currents of the electrical system;

FIG. 6 shows a bode plot for currents of the electrical system;

FIG. 7 shows an electrical system having multiple motor drives for the electric vehicle; and

FIG. 8 shows a flowchart of a method for determining a resonant frequency of a battery current for use in heating the battery.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

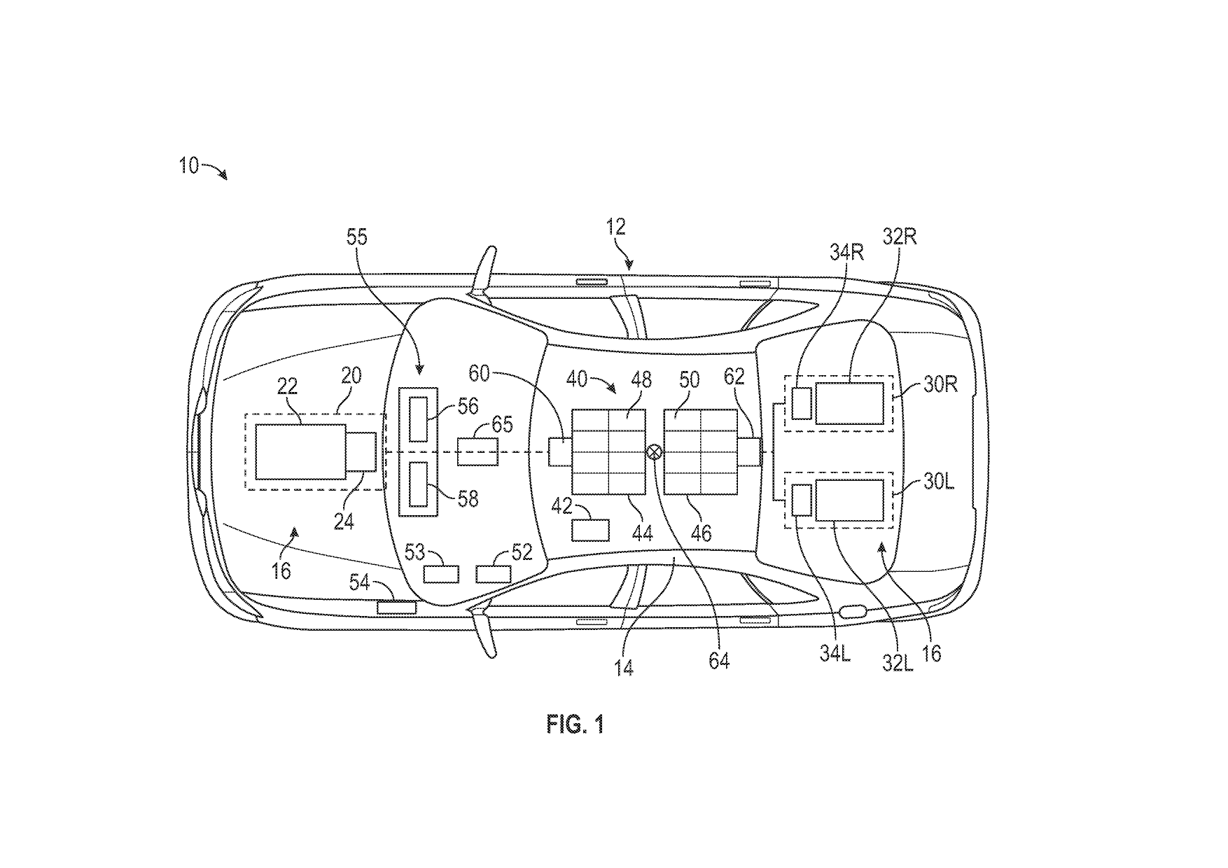

FIG. 1 shows an embodiment of a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a first plurality of battery modules 48, and the second battery pack 46 includes a second plurality of battery modules 50. Each of the first plurality of battery modules 48 and the second plurality of battery modules 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46, and selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for DC charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller includes any suitable processing device or unit, and may use an existing controller such as a drive system controller, an RESS controller, and/or controllers in the drive system. For example, a controller 65 may be included for controlling switching and drive control operations as discussed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In an alternative embodiment, the vehicle 10 can be an internal combustion engine vehicle, a hybrid vehicle, etc.

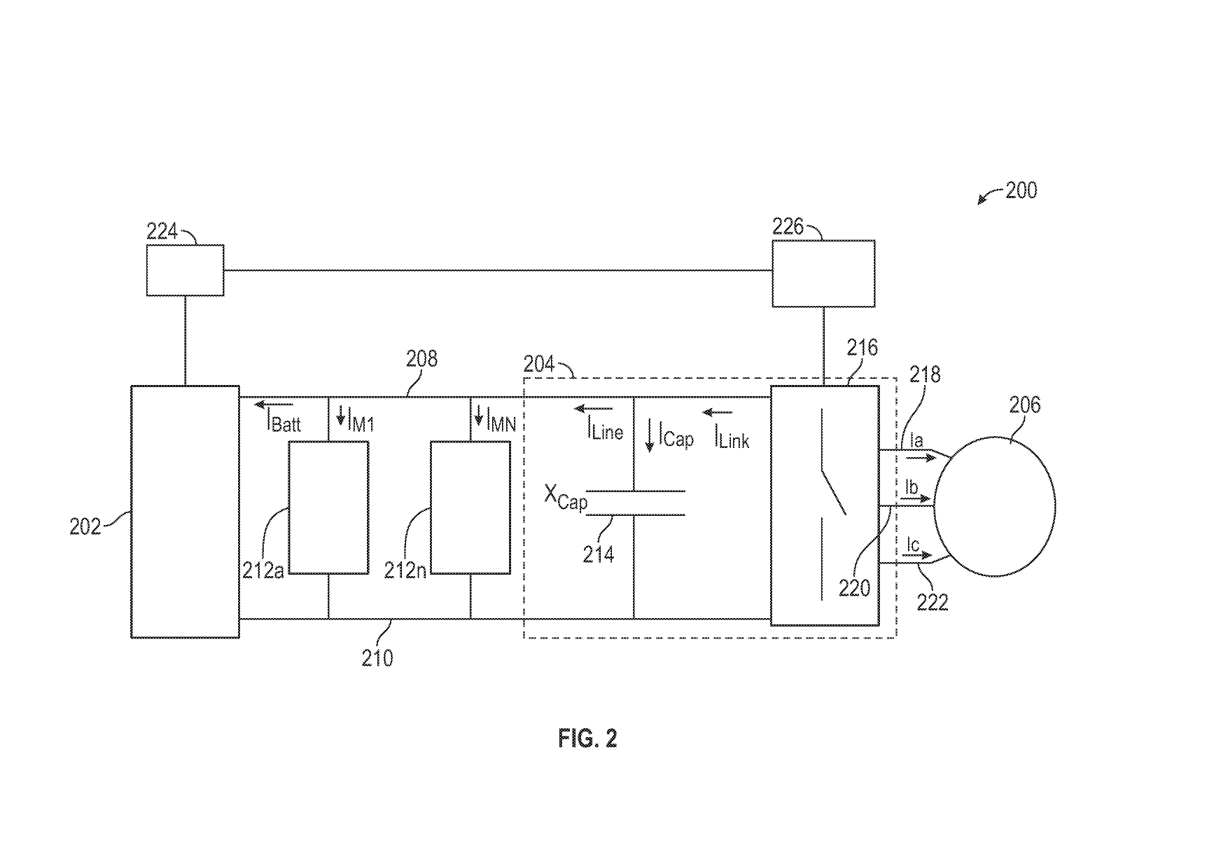

FIG. 2 is a schematic diagram of an electrical system 200 of the electric vehicle, in an illustrative embodiment. The electrical system includes a battery 202 or DC power source, an inverter 204 for converting between DC power and AC power, and an electric motor 206 that operates off of the AC power. A high voltage positive bus 208 connects a positive terminal of the battery 202 to the DC side of the inverter 204 and a high voltage negative bus 210 connects a negative terminal of the battery 202 to the DC side of the inverter. One or more high voltage modules 212a-212n can extend between the high voltage positive bus 208 and the high voltage negative bus 210. The one or more high voltage modules 212a-212n can be high voltage accessory loads.

The inverter 204 includes a capacitor 214 that extends between the high voltage positive bus 208 and the high voltage negative bus 210 and a switch box 216 in parallel with the capacitor 214. The switch box 216 includes three legs (not shown) extending from the high voltage positive bus 208 to the high voltage negative bus 210. Each leg includes two switches in series (not shown), which are operated to create an AC signal. The switches can be transistors such as, for example, MOSFET transistors and IGBT transistors. A phase winding connects to a midpoint between the two switches and is provided to the electric motor 206. A first phase winding 218 connects to the first leg and carries a first phase current (I a) of a three-phase voltage to the electric motor 206. A second phase winding 220 connects to the second leg and carries a second phase current (I b) to the electric motor 206. A third phase winding 222 connects to the third leg and carries a third phase current (I c).

Controller 226 can control operation of the switches of the inverter 204 to create a ripple current. The ripple current created at the inverter 204 generates a similar ripple current at the battery which can be used to warm the battery during cold conditions. A battery detector 224 measures various parameters of the battery 202, including battery current, battery voltage and battery temperature, for example. The battery detector 224 can be used to determine a peak in current, including a root mean square (RMS) peak. The battery parameters can be provided to the controller 226, which analyzes the battery parameters and controls the switches of the inverter 204.

The ripple current (I link) can be produced at the inverter 204 by operating the switches in an asynchronous manner to generate an unbalanced three phase current at the motor. The ripple current travels from the inverter 204 toward the battery along the high voltage positive bus 208. The ripple current separates into a capacitor current (I cap) and a line current (I line). The one or more high voltage modules 212a-212n carry module current (I_{M1}, … I_{MN}) which are generally insignificant. Therefore, a battery current (I batt) is approximately equal to the line current (I line).

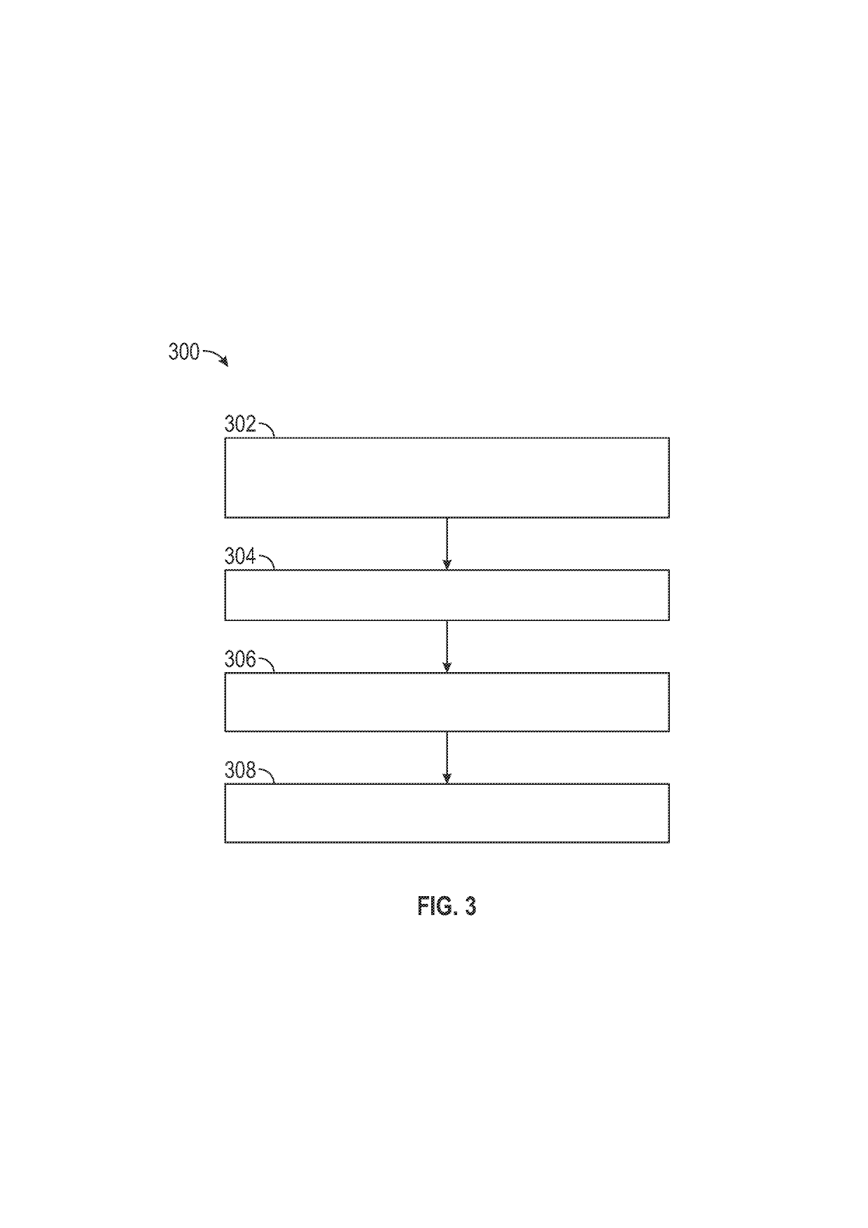

FIG. 3 shows a flowchart 300 of a method for determining an optimal frequency for warming a battery using a ripple current. In box 302, the inverter is operated to generate a ripple current. The frequency of the ripple current is swept through a plurality of frequencies and the magnitude of the ripple current is maintained the same at each frequency. In box 304, the battery current is detected at each frequency and recorded. In box 306, the frequency of the ripple current at which the battery current is at a maximum is identified. In box 308, the identified frequency is used at a subsequent time to create a subsequent ripple current for warming the battery. In various embodiments, the search for the resonance frequency can be repeated as the battery heats up.

A fundamental frequency of a winding current or ripple current along a d-axis of the motor (I d) can be adjusted so that it is the equal to or half of the resonance frequency. This allows for a maximum current gain at the battery while imparting no motion at the motor.

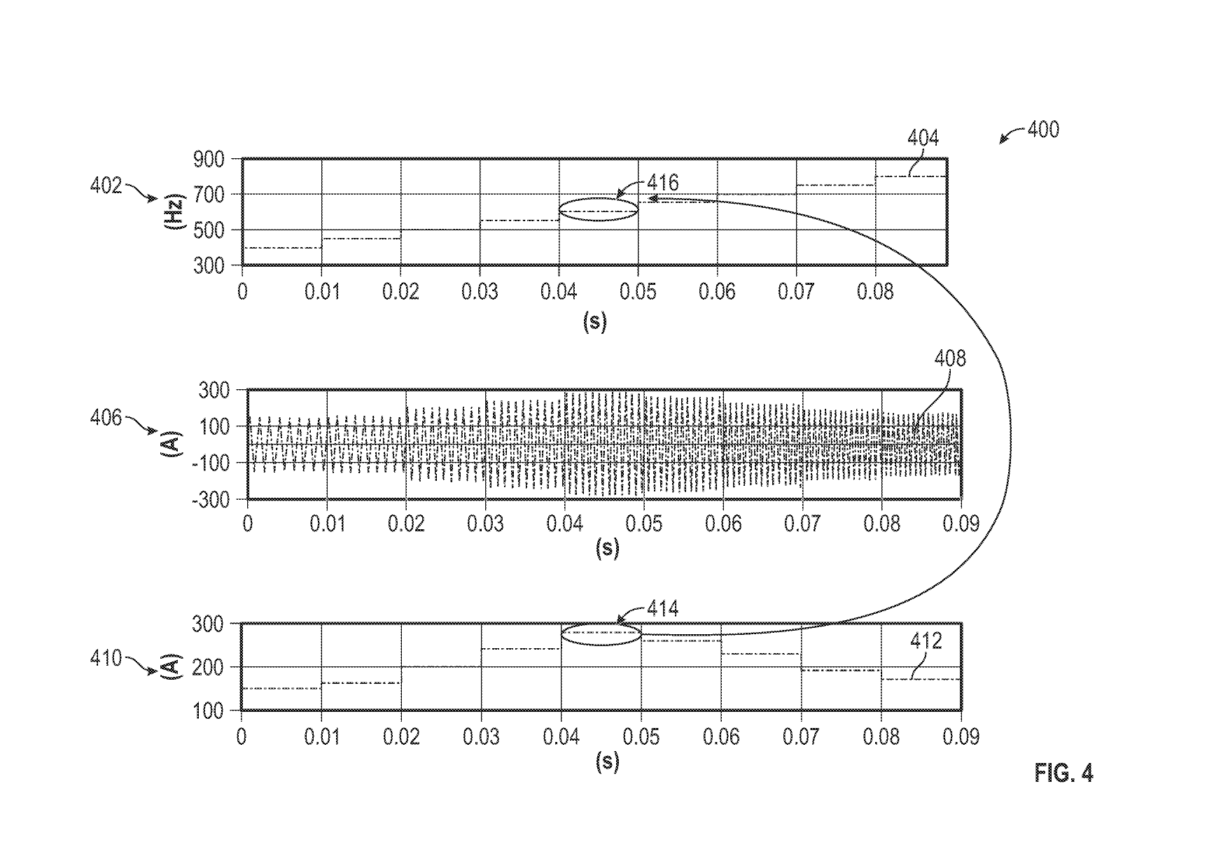

FIG. 4 shows three graphs 400 for illustrating the method for determining the optimal frequency disclosed by the flowchart of FIG. 3. A first graph 402 shows an injection current generated at the inverter. Time is shown along the abscissa in seconds (s) and frequency is shown along the ordinate axis in Hertz (Hz). An injection current curve 404 indicates the injection current being stepped up in frequency at selected time intervals. For illustrative purposes, the selected time interval is about 1/10 second and the step in frequency is about 50 Hz.

A second graph 406 indicates the battery current resulting from the injection current in first graph 402. Time is shown along the abscissa in seconds (s) and current is shown along the ordinate axis in Amps (A). A battery current curve 408 illustrates that the magnitude of the battery current changes with each frequency of the injection current curve 404.

A third graph 410 illustrates a peak battery current for the battery. Time is shown along the abscissa in seconds (s) and current is shown along the ordinate axis in Amps (A). A peak battery current curve 412 illustrates that a peak battery current 414 is about 275 A and occurs at a frequency of the injection current of about 600 Hz (shown at frequency step 416).

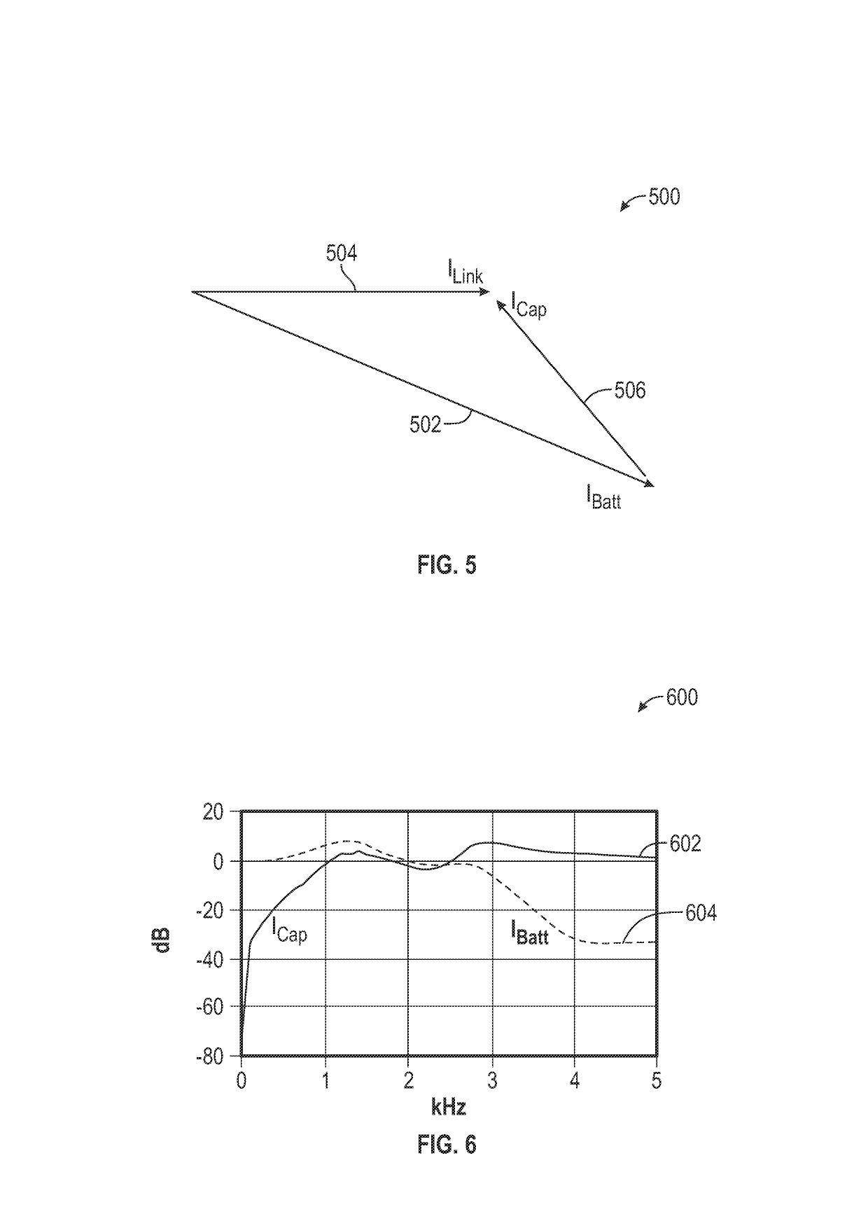

FIG. 5 shows a phase diagram 500 between currents of the electrical system 200. The phase diagram 500 includes a first phasor 502 representing a phase of the battery current, a second phase 504 representing a phase of the ripple current and a third phasor 506 representing a phase of a capacitor current. The magnitudes of the phase differences are related to the magnitudes of the currents. The phase diagram 500 illustrates that the battery current I batt can be the maximized for a given injection current I link.

FIG. 6 shows a bode plot 600 for currents of the electrical system. Frequency is shown along the abscissa in kilohertz (kHz) and gain is shown along the ordinate axis in decibels (dB). The injection current (not shown) is a source current of the bode plot 600. A first curve 602 shows a gain of the capacitor current (I cap) and a second curve 604 shows a gain of the battery current (I batt). The second curve 604 displays a resonant frequency range from about 1.13 kHz to about 1.44 kHz, with a resonant peak at 1.2kHz (a gain of about 2.5).

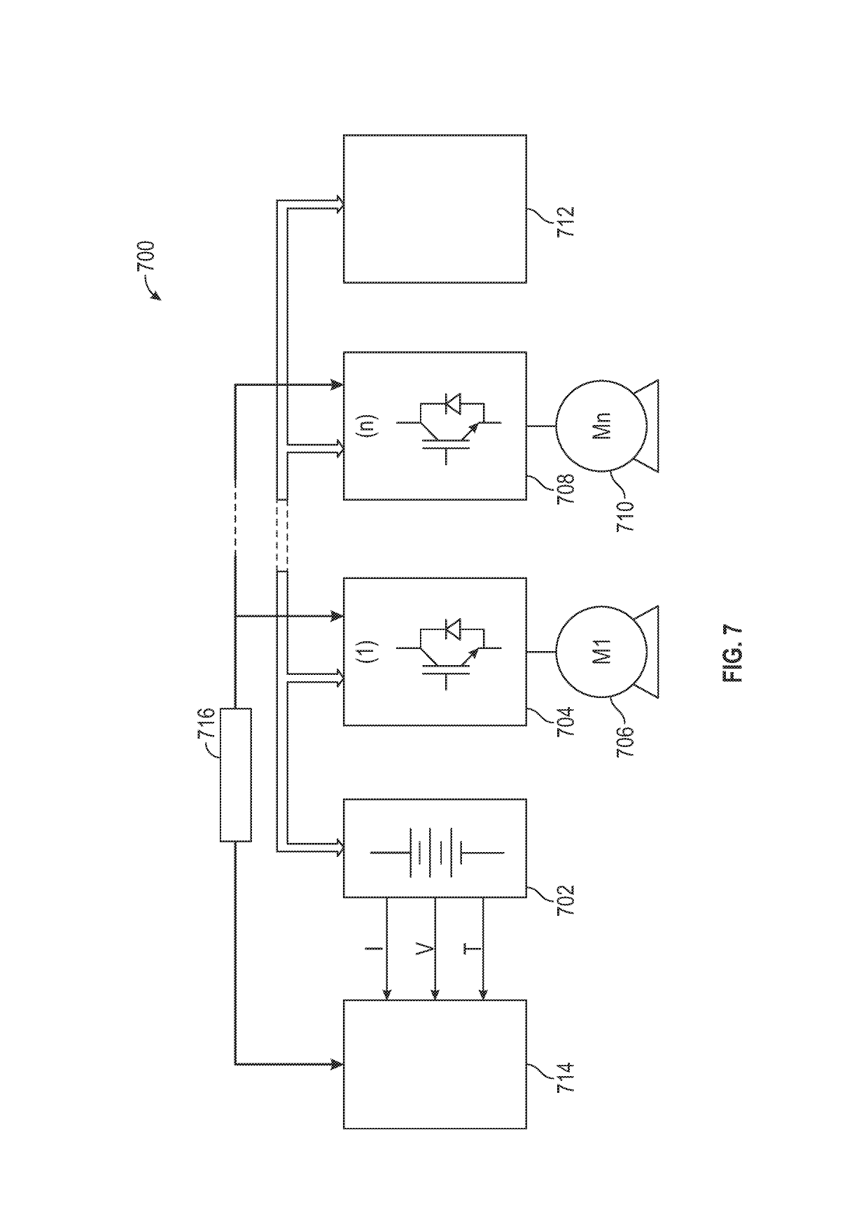

FIG. 7 shows an electrical system 700 having multiple motor drives for the electric vehicle. The electrical system 700 includes a battery 702, a first inverter 704 connecting the battery 702 to a first motor 706 and a second inverter 708 connecting the battery to a second motor 710. The electrical system 700 also includes various HV accessory loads 712. A battery detector 714 measures various parameters of the battery 702, including battery current, battery voltage and battery temperature. The battery parameters are provided to a controller 716 which analyzes the battery parameters and controls the switches of the first inverter 704 and the second inverter 708 based on the analysis, thereby determining a ripple current frequency suitable for warming the battery 702.

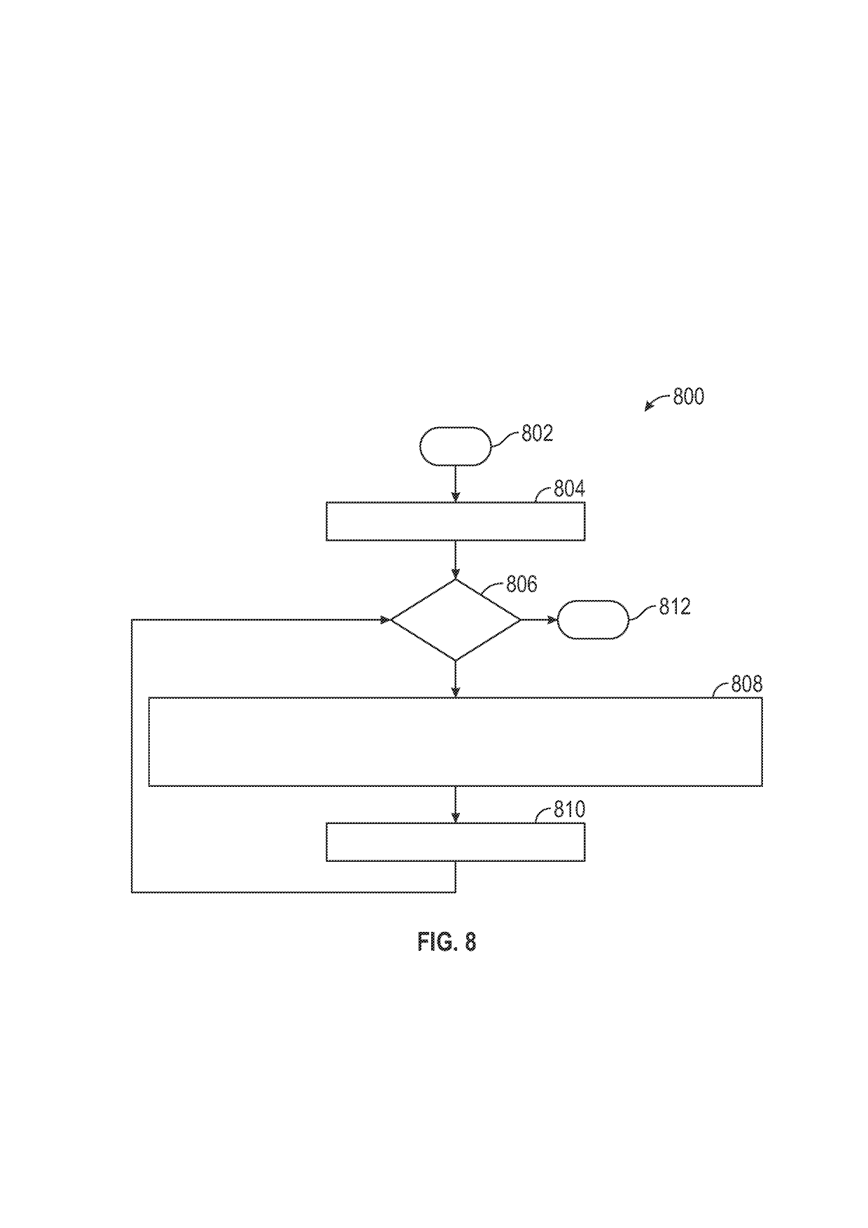

FIG. 8 shows a flowchart 800 of a method for determining a resonant frequency of a battery current for use in heating the battery 702. The method begins in box 802. In box 804, a peak detector/RMS value for the battery detector 714 is reset or initialized. In box 806, a motor index i is increased. The value of the motor index i ranges from 1, …, n, where n is the number of motors in the electrical system 700. If i<=n, then the method proceeds to box 808. However, if i>n, the method proceeds to box 812, wherein the process ends.

Turning to box 808, the frequency of the first motor (first inverter) is swept through a range of frequencies from a minimum frequency to a maximum frequency to determine a resonance frequency corresponding to a maximum battery current. In box 810, the peak detector/RMS value is reset. The method then returns to box 806. In box 806, the value of the motor counter is increased.

Once the resonance frequencies are determined for each motor, the motor with the greatest gain for battery current can be used.

In an embodiment with two motors, a first resonance frequency can be determined for a first ripple current at the first inverter that corresponds to a first peak in the gain of the battery current and a second resonance frequency can be determined for a second ripple current at the second inverter that corresponds to a second peak in the gain of the battery current. The greater of the first peak and the second peak can be found and one of the first inverter and the second inverter can be selected to heating the battery based on which the first peak and the second peak is greatest. This process can be extended to n motors.

In various embodiments, a frequency and phase for operating the first motor and the second motor and a phase difference between the first motor and second motor can be determined that provides an optimal heating at the battery.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A method of heating a battery of a vehicle, comprising:
sweeping a ripple current at an inverter of the vehicle through a plurality of frequencies, wherein the inverter is associated with the battery;
detecting a plurality of battery currents at the battery in response to the ripple current, wherein a battery current of the plurality of battery currents corresponds to a frequency of the ripple current;
determining a magnitude for each battery current;
determining a resonance frequency of the ripple current for which the magnitude of the battery current is a maximum; and
operating the inverter at the resonance frequency of the ripple current to heat the battery.

2. The method of claim 1, further comprising creating the ripple current at the inverter by operating switches of the inverter asynchronously.

3. The method of claim 1, wherein the inverter is coupled between the battery and a motor and the ripple current is injected into the motor along a d-axis of the motor.

4. The method of claim 3, further comprising adjusting a fundamental frequency of the ripple current along the d-axis to be one of: (i) equal to the resonance frequency; and (ii) half of the resonance frequency.

5. The method of claim 1, wherein the inverter includes a first inverter between the battery and a first motor and a second inverter between the battery and a second motor, further comprising determining a first resonance frequency for a first ripple current at the first inverter that corresponds to a first peak in a gain of the battery current, determining a second resonance frequency for a second ripple current at the second inverter that corresponds to a second peak in the gain of the battery current, and selecting one of the first inverter and the second inverter for heating the battery based on which the first peak and the second peak is greatest.

6. The method of claim 5, further comprising determining a frequency and phase for operating a first motor associated with the first inverter and a second motor associated with the first inverter and a phase difference between the first motor and the second motor for optimal heating at the battery.

7. The method of claim 1, further comprising repeating sweeping of the ripple current to determine the resonance frequency at a subsequent time as the battery heats up.

8. An electrical system of a vehicle, comprising:
a battery;
an inverter electrically coupled to the battery; and
a processor configured to:
sweep a ripple current at the inverter through a plurality of frequencies, wherein the inverter is associated with the battery;
detect a plurality of battery currents at the battery in response to the ripple current, each battery current of the plurality of battery currents corresponding to a frequency of the ripple current;
determine a magnitude for each battery current;
determine a resonance frequency of the ripple current for which the magnitude of the battery current is a maximum; and
operate the inverter at the resonance frequency of the ripple current to heat the battery.

9. The electrical system of claim 8, wherein the processor is further configured to create the ripple current at the inverter by operating switches of the inverter asynchronously.

10. The electrical system of claim 8, wherein the inverter is coupled between the battery and a motor and the ripple current is injected into the motor along a d-axis of the motor.

11. The electrical system of claim 10, wherein the processor is further configured to adjust a fundamental frequency of the ripple current along the d-axis to be one of: (i) equal to the resonance frequency; and (ii) half of the resonance frequency.

12. The electrical system of claim 8, wherein the inverter includes a first inverter between the battery and a first motor and a second inverter between the battery and a second motor and the processor is further configured to determine a first resonance frequency for a first ripple current at the first inverter that corresponds to a first peak in a gain of the battery current, determine a second resonance frequency for a second ripple current at the second inverter that corresponds to a second peak in the gain of the battery current, and select one of the first inverter and the second inverter for heating the battery based on which the first peak and the second peak is greatest.

13. The electrical system of claim 12, wherein the processor is further configured to determine a frequency and phase for operating a first motor associated with the first inverter and a second motor associated with the second inverter and a phase difference between the first motor and the second motor for optimal heating at the battery.

14. The electrical system of claim 8, wherein the processor is further configured to repeat sweeping of the ripple current to determine the resonance frequency at a subsequent time as the battery heats up.

15. A vehicle, comprising:
a battery;
an inverter electrically coupled to the battery;
a detector coupled to the battery for detecting a plurality of battery currents at the battery; and
a processor configured to:
sweep a ripple current at the inverter through a plurality of frequencies, wherein the inverter is associated with the battery;
receive the plurality of battery currents from the detector in response to the ripple current, each battery current of the plurality of battery currents corresponding to a frequency of the ripple current;
determine a magnitude for each battery current;
determine a resonance frequency of the ripple current for which the magnitude of the battery current is a maximum; and
operate the inverter at the resonance frequency of the ripple current to heat the battery.

16. The vehicle of claim 15, wherein the processor is further configured to create the ripple current at the inverter by operating switches of the inverter asynchronously.

17. The vehicle of claim 15, wherein the inverter is coupled between the battery and a motor and the ripple current is injected into the motor along a d-axis of the motor.

18. The vehicle of claim 17, wherein the processor is further configured to adjust a fundamental frequency of the ripple current along the d-axis to be one of: (i) equal to the resonance frequency; and (ii) half of the resonance frequency.

19. The vehicle of claim 15, wherein the inverter includes a first inverter between the battery and a first motor and a second inverter between the battery and a second motor and the processor is further configured to determine a first resonance frequency for a first ripple current at the first inverter that corresponds to a first peak in a gain of the battery current, determine a second resonance frequency for a second ripple current at the second inverter that corresponds to a second peak in the gain of the battery current, and select one of the first inverter and the second inverter for heating the battery based on which the first peak and the second peak is greatest.

20. The vehicle of claim 19, wherein the processor is further configured to determine a frequency and phase for operating a first motor associated with the first inverter and a second motor associated with the first inverter and a phase difference between the first motor and the second motor for optimal heating at the battery.
